(19) United States
(12) Patent Application Publication
(10) Pub. No.: US 2012/0255036 A1
(43) Pub. Date: Oct. 4, 2012

(54) PROPRIETARY ACCESS CONTROL ALGORITHMS IN CONTENT DELIVERY NETWORKS

(75) Inventor: Scott Kidder, Benicia, CA (US)

(73) Assignee: MOBITV, INC., Emeryville, CA (US)

(21) Appl. No.: 13/075,034

(22) Filed: Mar. 29, 2011

(51) Int. Cl. G06F 21/00; G06F 15/16

(52) U.S. Cl. 726/29

(57) ABSTRACT

Mechanisms are provided to allow application of proprietary access control algorithms during requests for resources obtained using a content delivery network (CDN). Requests to a CDN are augmented with a content provider specific token. The content provider can maintain strict control over access to restricted content at the time of request with a proprietary authorization algorithm and maintains real-time usage information for restricted content.

### DESCRIPTION OF RELATED ART

The present disclosure relates to mechanisms for applying proprietary access control algorithms in content delivery networks.

### DESCRIPTION OF RELATED ART

It is often desirable to use content delivery networks (CDNs) to distribute resources such as media content to clients. CDNs have scalable network and server capacity to meet client demand. However, CDNs do not typically allow for fine grained access control to resources. Consequently, the techniques and mechanisms of the present invention provide improved mechanisms for applying proprietary access control algorithms in content delivery networks.

### Overview

Mechanisms are provided to allow application of proprietary access control algorithms during requests for resources obtained using a content delivery network (CDN). Requests to a CDN are augmented with a content provider specific token. The content provider can maintain strict control over access to restricted content at the time of request with a proprietary authorization algorithm and maintains real-time usage information for restricted content.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a network that can use the techniques and mechanisms of the present invention.

FIG. 2 illustrates a particular example of an origin server.

FIG. 3 illustrates a particular example of a client request.

FIG. 4 illustrates a particular example of a content delivery network (CDN) processing a client request for content not available in cache.

FIG. 5 illustrates a particular example of a CDN processing a client request for content available in cache.

FIG. 6 illustrates a particular example of a client device.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices such as mobile devices. However, it should be noted that the techniques and mechanisms of the present invention can be used with a variety of devices including general computing devices. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Many organizations rely on content delivery networks (CDNs) to efficiently deliver content to clients. CDNs generally have the network bandwidth and server capacity to scale up and down with client demand. It is often more economical for a content publisher to partner with a CDN to deliver content. Otherwise, the publisher may end up underinvesting or overinvesting in hardware and network capacity.

CDNs typically function by receiving requests from clients, checking a local cache for a copy of the requested resource, querying the origin server belonging to the publisher if the requested resource is missing from the cache or has expired, and then returning the resource to the client and storing it in cache for use with future requests. CDN servers are typically strategically located at the edges of various networks to limit loads on network interconnects and backbones. CDN servers are often redundantly deployed and interact with other CDN servers to respond to content requests from clients and optimize content delivery. Optimization may include bandwidth usage reduction, latency reduction, and improved availability.

However, a shortcoming of CDNs is that they typically do not allow for fine-grained access-control to network resources. Once the content is in cache, the function of access-control is left to the CDN. The access control systems employed by CDNs usually are meant to serve the greatest common denominator. This does not permit the fine-grained access-control that some organizations require.

Consequently, the techniques and mechanisms of the present invention allow application of proprietary access-control algorithms for resources delivery using a CDN. According to various embodiments, the CDN does not possess any knowledge or proprietary algorithm details, or that a proprietary algorithm even exists.

Several CDNs can be configured to support security tokens generated using an algorithm common to all resource providers or customers of the CDN. In some examples, all resource providers can generate tokens. The tokens are cryptographically signed to prevent tampering and carry a payload that is time-sensitive. The tokens will eventually expire and become invalid. Requests for protected resources from a CDN include the token and the CDN verifies that the tokens are present and valid before providing restricted resources. Resources include media content, services, data, etc. Resource providers may include pay per view (PPV) media content delivery services, application service providers, etc.

However, many mechanisms do not allow for application of proprietary algorithms specific to individual resource providers. Additionally, resource providers are typically not privy to protect resource access metrics.

Some CDNs will rely entirely on an origin server for fine-grained access-control to resources. Requests received at a CDN server may be routed to an origin server for authorization. However, routing numerous requests to an origin server eliminates many of the benefits of using a CDN in the first place.

According to various embodiments, a system for applying proprietary access control alogirhtms in a CDN includes an origin server, a CDN server, a client, and a token generator. A client may be a mobile device, smartphone, computing system, etc. According to various embodiments, a client may want to access restricted content such as PPV movies, application services, etc.

According to various embodiments, a client requests a token from the token generator. The token generator may be associated with a resource provider or even integrated with an origin server. The conditions of use for the token may not be known by the client. This might include the time sensitivity or scope of the token. The token generator may require that the client provide details of the resource that it intends to access in order for a token to be provided. The origin server is capable of authenticating tokens produced by the token generator. This might be accomplished through a shared secret or a public key infrastructure (PKI).

In particular embodiments, the client requests a resource through the CDN using the token obtained from the token generator. The token may be specified in a way such that it is not a part of the cache path for the resource on the CDN. This may include, but is not limited to, passing the token as a URL query parameter or in a hypertext transfer protocol (HTTP) header or cookie. According to various embodiments, the CDN determines whether the resource is currently in cache. If the resource is not cached, the CDN contacts the origin server to determine if the request is authorized. In particular embodiments, the origin server may create an audit record identifying the requested resource, the time of request, the token used in the request, as well as other data.

According to various embodiments, the origin server applies a proprietary authentication algorithm to the request to determine if the request is authorized. Evaluation may include evaluating the token as a universal resource locator (URL) query parameter or in an HTTP header or cookie. If the token is authorized, an origin server returns the content with a must-revalidate response header. If the token is not authorized, the origin server returns a response indicating that access to the resource is not authorized. If the origin server indicates that the request is authorized, then the CDN stores the origin server response in cache and returns the resource to the client with a must-revalidate response header. If the origin server indicates that the request is not authorized, the CDN returns a response to the client indicating that the request was not authorized.

If the resource requested by the client is cached at the CDN, the CDN contacts the origin server to revalidate the request. According to various embodiments, the CDN contacts the origin server to determine if the request is authorized and if the requested resource has changed. In particular embodiments, the origin server may create an audit record identifying the requested resource, the time of request, the token used in the request, and other data. According to various embodiments, the origin server applies a proprietary authentication algorithm to the request to determine if the request is authorized. The proprietary authentication algorithm may include evaluating the token as a URL query parameter or in an HTTP header or cookie. If the token is authorized and the resource has not changed on the origin server, then the origin server indicates the token is authorized and provides a response indicating that the cached content has not changed. According to various embodiments, a must revalidate response header is also provided. If the resource has changed on the origin server, the resource is returned from the origin server with a must-revalidate response header.

If the proprietary algorithm indicates that the token is not authorized, a response is provided to the CDN indicating that the token is not authorized. The resource at the origin server may or may not have changed at the origin server. If the origin server indicated that the request is authorized, the cached content is sent to the client. Otherwise, content in cache is preserved, but a response is sent to the client indicating that the request is not authorized. A content publisher might receive access logs from a CDN indicating the access activity for restricted content. These logs might be cross-referenced with the audit logs created at the origin server. The results of access activity in generating reports for the publisher and other content stakeholders.

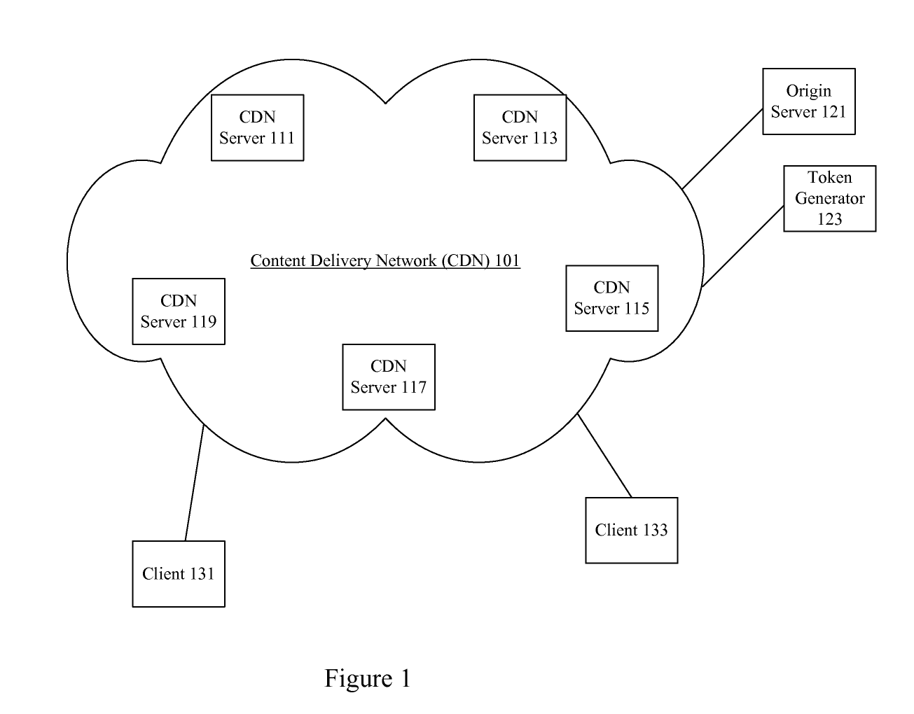

FIG. 1 illustrates one example of a CDN that can be used with various embodiments. According to various embodiments, a CDN 101 includes CDN servers 111, 113, 115, 117, and 119. In particular embodiments, CDN servers are strategically deployed to enhance content delivery performance. CDN servers may also be referred to surrogate servers or content replica servers. Effective CDN server placement may reduce the number of servers needed as well as the number of times content has to be replicated. A variety of algorithms can be used to deploy CDNs. Greedy algorithms continually make locally optimal choices with the hope of finding a global optimum. Hot spot algorithms place CDN servers near the clients generating the greaqtest load. Treebased algorithms specify the locations of CDN servers to achieve particular levels of performance.

The number of CDN servers may vary from the dozens to thousands and distribute content from origin server 121. Although an origin server 121 may have very specific mechanisms for determining what clients have access to particular pieces of content, once the content is distributed onto a CDN 101, the origin server 121 has limited access control mechanisms. For example, client 131 may be authorized to access a particular restricted piece of content for a limited period of time. However, the client 131 may be authorized to access a different restricted piece of content for an extended period of time. Alternatively, different versions of content may be provided to different clients based on purchased packages.

According to various embodiments, a client request for content is typically algorithmically directed at a CDN server that can efficiently serve the client request. In order to verify that a particular client 131 has access to a piece of restricted content, a request may be sent to an origin server 121 to perform verification after a client 131 obtains a token from a token generator 123.

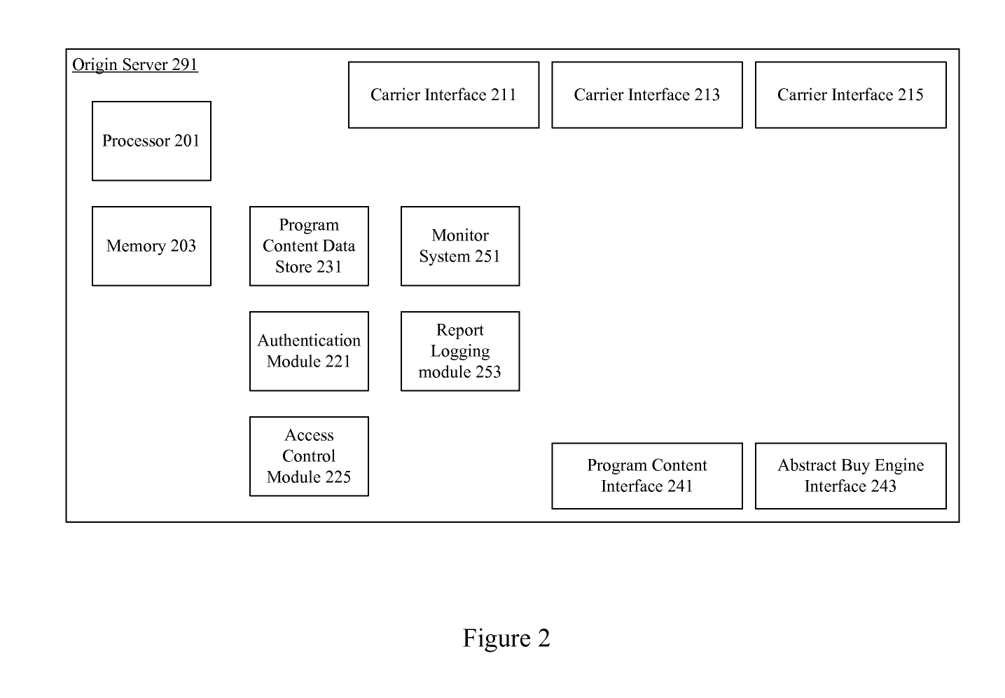

FIG. 2 is a diagrammatic representation showing one example of an origin server 291. According to various embodiments, the origin server 291 includes a processor 201, memory 203, and a number of interfaces. In some examples, the interfaces include a program content interface 241 allowing the origin server 291 to obtain program content information. The origin server 291 also can include a program content data store 231 configured to store program content such as video clips, pay per view content, movies, programs, and live or near-live streams. The origin server 291 can also maintain static information such as icons and menu pages. The interfaces also include a carrier interface 211 allowing operation with mobile devices such as cellular phones operating in a particular cellular network. The carrier interface allows a carrier vending system to update subscriptions. Carrier interfaces 213 and 215 allow operation with mobile devices operating in other wireless networks. An abstract buy engine interface 243 provides communication with an abstract buy engine that maintains subscription information.

An authentication module 221 verifies the identity of mobile devices. Access control module 225 associated with authentication module 221 determines whether a token provided with a request provides a client with access to a particular piece of restricted content at a given time. For example, an access control module may determine that a client should have access to a program for another 12 hours.

In many implementations without CDNs, the origin server 291 can apply specific access control algorithms using information associated with the client. However, when CDNs distribute the content, CDNs typically do not allow for the same degree of access control and may provide a client with requested content regardless of desired access control algorithms. Alternatively, the CDN may forward all client requests for content to an origin server 291 for the access control module 225 to handle access restrictions. However, forwarding requests to the origin server 291 removes some of the primary benefits of using CDNs.

A logging and report generation module 253 tracks mobile device requests and associated responses. A monitor system 251 allows an administrator to view usage patterns and system availability. According to various embodiments, the origin server 291 handles requests and responses for media content related transactions and provides actual content. In particular embodiments, requests for content and actual content distribution can be handled by separate servers. In some embodiments, the origin server 291 can also be configured to provide media clips and files to a client in a manner that supplements a streaming server.

Although a particular origin server 291 is described, it should be recognized that a variety of alternative configurations are possible. For example, some modules such as a report and logging module 253 and a monitor 251 may not be needed on every server. Alternatively, the modules may be implemented on another device connected to the server. In another example, the server 291 may not include an interface to an abstract buy engine and may in fact include the abstract buy engine itself. A variety of configurations are possible.

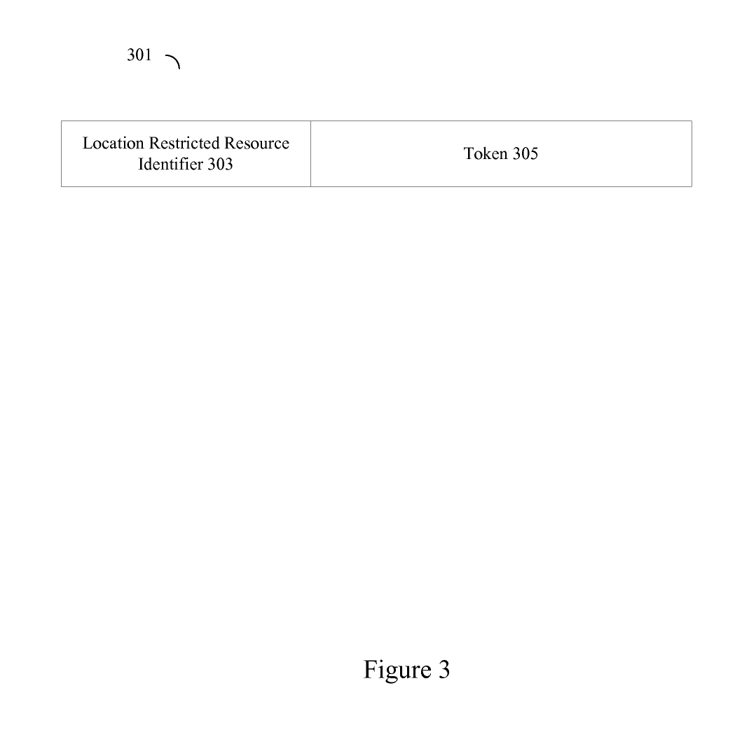

FIG. 3 illustrates a particular example of a client request. According to various embodiments, a client request 301 to a CDN includes a restricted content identifier 303 and a token 305. The token may be included as a URL query parameter or in an HTTP header or cookie. In particular embodiments, the token may be specified so that it is not a part of the cache path for the resource on the CDN. According to various embodiments, the token is obtained from a token generator and may be encrypted.

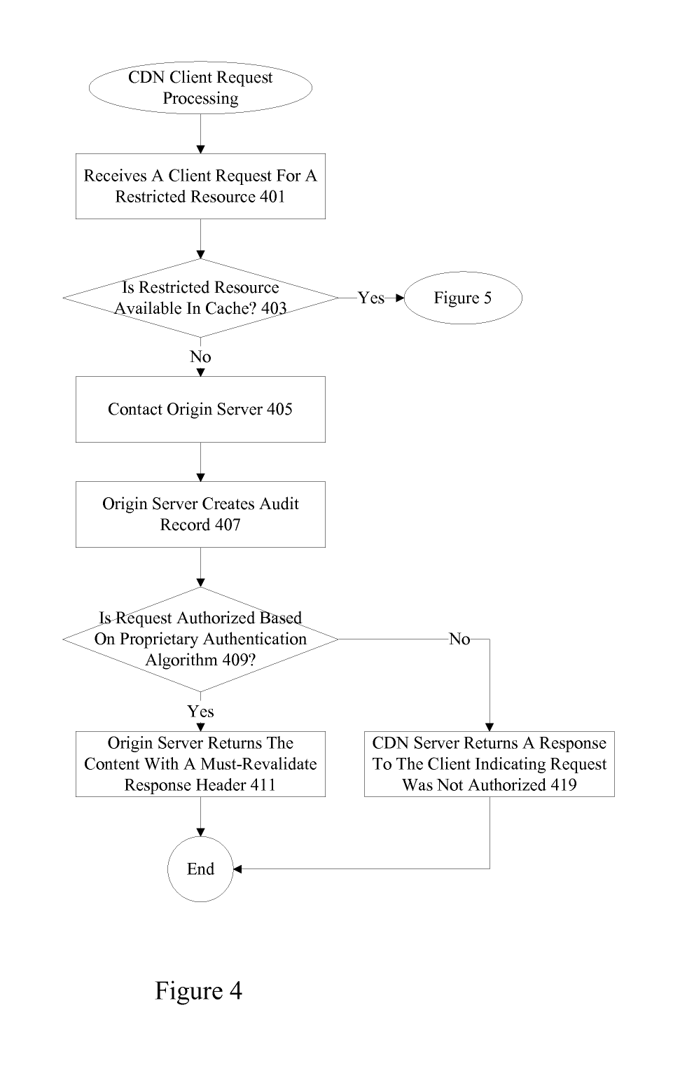

FIG. 4 illustrates a particular example of a CDN processing a client request. According to various embodiments, a CDN receives a request from a client at 401. The request includes a restricted resource identifier and a token obtained from the token generator. The token may be specified in a way such that it is not a part of the cache path for the resource on the CDN. According to various embodiments, the CDN server determines at 403 whether the resource is currently in a cache accessible to the CDN server. If the resource is not cached at 403, the CDN server contacts the origin server at 405 to determine if the request is authorized. In particular embodiments, the origin server may create an audit record at 407 identifying the requested resource, the time of request, the token used in the request, as well as other data.

According to various embodiments, the origin server applies a proprietary authentication algorithm to the request at 409 to determine if the request is authorized. Evaluation may include evaluating the token as a universal resource locator (URL) query parameter or in an HTTP header or cookie. If the token is authorized at 409, an origin server returns the content with a must-revalidate response header at 411. If the token is not authorized, the origin server returns a response indicating that access to the resource is not authorized at 413. If the origin server indicates that the request is authorized, then the CDN stores the origin server response in cache at 415 and returns the resource to the client with a must-revalidate response header at 417. If the origin server indicates that the request is not authorized, the CDN returns a response to the client indicating that the request was not authorized at 419.

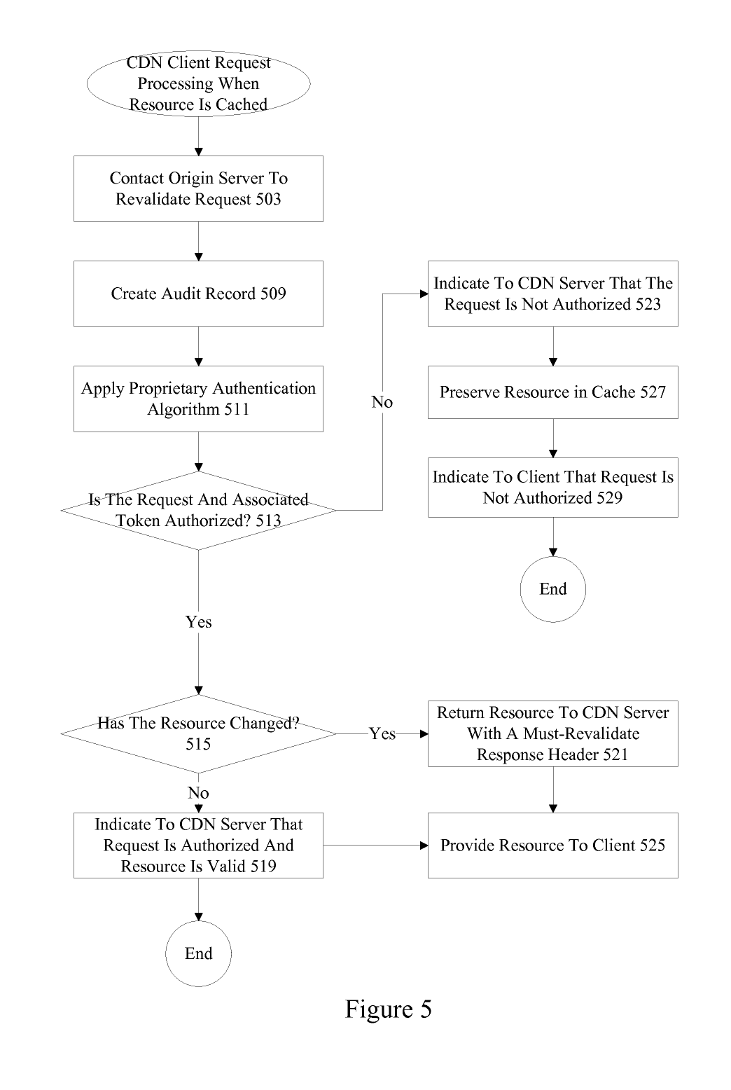

FIG. 5 illustrates an example of resource request handling when the resource is cached. If the resource requested by the client is cached at the CDN, the CDN contacts the origin server to revalidate the request 503. According to various embodiments, the CDN contacts the origin server to determine if the request is authorized and if the requested resource has changed. In particular embodiments, the origin server may create at 509 an audit record identifying the requested resource, the time of request, the token used in the request, and other data.

According to various embodiments, the origin server applies a proprietary authentication algorithm at 511 to the request to determine if the request is authorized. The proprietary authentication algorithm may include evaluating the token as a URL query parameter or in an HTTP header or cookie. The origin server determines at 513 if the token is authorized and whether the resource has changed on the origin server at 515. If the token is authorized and the resource has not changed on the origin server, then the origin server indicates the token is authorized and provides a response indicating that the request is authorized and the cached content has not changed at 519. According to various embodiments, a must revalidate response header is also provided. If the resource has changed on the origin server, the resource is returned from the origin server with a must-revalidate response header at 521.

If the proprietary algorithm indicates that the token is not authorized, a response is provided to the CDN indicating that the token is not authorized at 523. The resource at the origin server may or may not have changed at the origin server.

At the CDN, if the origin server indicated that the request is authorized, the cached content is sent to the client at 525. Otherwise, content in cache is preserved at 527, but a response is sent to the client indicating that the request is not authorized at 529. A content publisher might receive access logs from a CDN indicating the access activity for restricted content. These logs might be cross-referenced with the audit logs created at the origin server. The results of access activity in generating reports for the publisher and other content stakeholders.

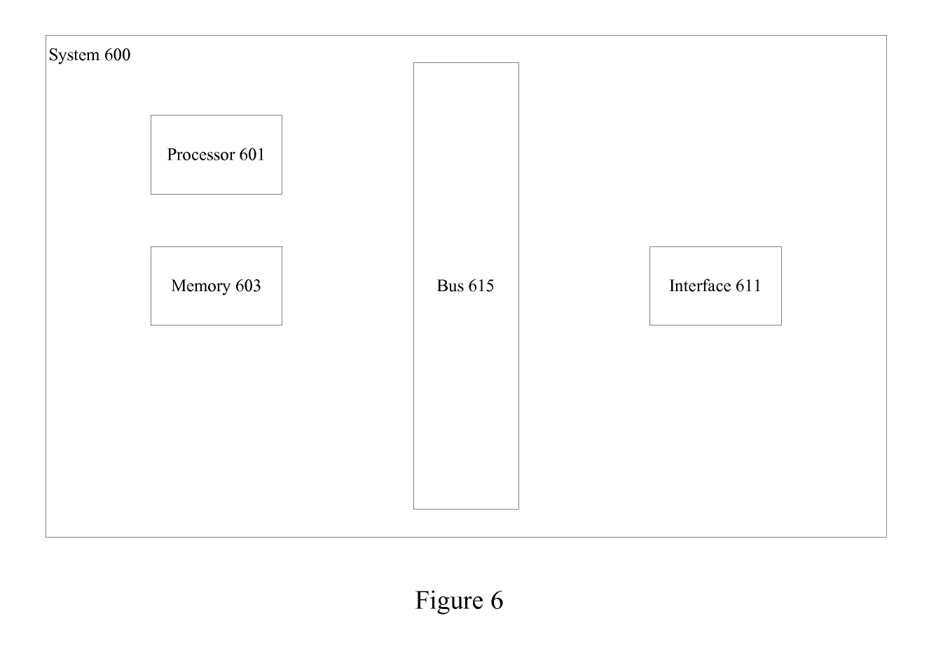

FIG. 6 illustrates one example of a server that can be used to apply proprietary access control algorithms. According to particular embodiments, a system 600 suitable for implementing particular embodiments of the present invention includes a processor 601, a memory 603, an interface 611, and a bus 615 (e.g., a PCI bus or other interconnection fabric) and operates as a streaming server. When acting under the control of appropriate software or firmware, the processor 601 is responsible for modifying and transmitting live media data to a client. Various specially configured devices can also be used in place of a processor 601 or in addition to processor 601. The interface 611 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 600 is a content server that also includes a transceiver, streaming buffers, and a program content database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 691 handles requests and responses for media content related transactions while a separate streaming server provides the actual media streams.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving a resource request from a client, the resource request received at a content delivery network server, the resource request including a restricted resource content identifier and a token;
determining that the restricted resource is not available in a cache associated with the content delivery network server;
contacting an origin server to determine if the resource request is authorized, wherein the origin server applies a proprietary authentication algorithm using the token to determine if the resource request is authorized, wherein if the resource request is authorized, the content is returned from the origin server to the content delivery network server with a must-revalidate response header.

2. The method of claim 1, wherein the token is obtained from a token generator.

3. The method of claim 1, wherein the token is generated after the client provides information about the resource request.

4. The method of claim 1, wherein applying a proprietary authentication algorithm comprises evaluating the token as a universal resource locator (URL) query parameter.

5. The method of claim 1, wherein applying a proprietary authentication algorithm comprises evaluating the token as an hypertext transfer protocol (HTTP) header or cookie.

6. The method of claim 1, wherein if the resource request is not authorized, the origin server indicates to the content delivery network server that the resource request is not authorized.

7. The method of claim 1, wherein the origin server creates an audit record identifying the requested resource, the time of request, and the token used.

8. A method, comprising:
receiving a resource request from a client, the resource request received at a content delivery network server, the resource request including a restricted resource content identifier and a token;
determining that the restricted resource is available in a cache associated with the content delivery network server;
contacting an origin server to determine if the resource request is authorized and if the restricted resource has changed even though the restricted resource is available in the cache associated with the content delivery network server, wherein the origin server applies a proprietary authentication algorithm using the token to determine if the resource request is authorized.

9. The method of claim 8, wherein if the resource request is authorized and the restricted resource has not changed, a response is provided to the content delivery network server indicating that resource request is authorized and the cached content has not changed.

10. The method of claim 8, wherein if the resource request is authorized and the restricted resource has changed, a response is provided to the content delivery network server with a must-revalidate response header.

11. The method of claim 8, wherein the token is obtained from a token generator.

12. The method of claim 11, wherein the token is generated after the client provides information about the resource request.

13. The method of claim 8, wherein applying a proprietary authentication algorithm comprises evaluating the token as a universal resource locator (URL) query parameter.

14. The method of claim 8, wherein applying a proprietary authentication algorithm comprises evaluating the token as an hypertext transfer protocol (HTTP) header or cookie.

15. The method of claim 8, wherein if the resource request is not authorized, the restricted resource is maintained in the cache associated with the content delivery network server and a response is sent to the client indicating that the request is not authorized.

16. A server, comprising:
an interface configured to receive a resource request from a client, the resource request including a restricted resource content identifier and a token;
a processor configured to determine that the restricted resource is not available in a cache associated with the server and contact an origin server to determine if the resource request is authorized, wherein the origin server applies a proprietary authentication algorithm using the token to determine if the resource request is authorized, wherein if the resource request is authorized, the content is returned from the origin server to the content delivery network server with a must-revalidate response header.

17. The server of claim 16, wherein the token is obtained from a token generator.

18. The server of claim 16, wherein the token is generated after the client provides information about the resource request.

19. The server of claim 16, wherein applying a proprietary authentication algorithm comprises evaluating the token as a universal resource locator (URL) query parameter.

20. The server of claim 16, wherein applying a proprietary authentication algorithm comprises evaluating the token as an hypertext transfer protocol (HTTP) header or cookie.
